(19) United States
(12) Patent Application Publication
(10) Pub. No.: US 2023/0216950 A1
(43) Pub. Date: Jul. 6, 2023

(54) SCRATCH RESISTANT CORRECTIVE SMART DEVICE OVERLAY

(71) Applicant: Midas Touch Global LLC, Jericho, NY (US)

(72) Inventor: Julius Reich, Jericho, NY (US)

(73) Assignee: Midas Touch Global LLC, Jericho, NY (US)

(21) Appl. No.: 17/566,937

(22) Filed: Dec. 31, 2021

(51) Int. Cl. H04M 1/72481; H04M 1/72409; H04M 1/72448; H04M 1/72469; H04M 1/72466; G02B 1/14

(52) U.S. Cl. CPC H04M 1/72481; H04M 1/72409; H04M 1/72448; H04M 1/72469; H04M 1/72466; G02B 1/14

(57) ABSTRACT

The invention of the present disclosure may be an overlay for use with a smart device having a touch screen, the overlay comprising a protective layer configured to prevent damage to the touch screen, the protective layer having a protective layer height; a corrective layer configured to correct an image displayed by the touch screen, the corrective layer having a corrective layer prescription and a corrective layer height, wherein the corrective layer prescription is a function of at least a viewing distance and a user prescription; and an adhesive layer configured to attach the overlay to the touch screen, the adhesive layer having an adhesive layer height, wherein the corrective layer is disposed above the adhesive layer, and the protective layer is disposed above the corrective layer, and wherein the protective layer, the corrective layer, and the adhesive layer each have the same surface area.

### FIELD OF INVENTION

The invention is in the field of smart device accessories, specifically apparatuses that interface with smart devices to correct images for individuals with visual impairments.

### INTRODUCTION

Currently, most individuals interact with multiple smart devices each day. For example, the average individual may spend many hours viewing their smart phone, tablet device, smart watch, or personal computer. However, many of these same individuals suffer from various visual impairments, often requiring eyeglasses or contact lenses. Accordingly, without visual aids, many smart devices users cannot clearly see the displays of their smart devices. Specifically, many individuals suffer from hyperopia (farsightedness) and therefore exhibit difficulty in viewing smart device screens within several feet of their eyes.

Further, in increasing frequency, the average person spends a great deal of leisure time interacting with smart devices. Accordingly, for those seeking to relax and view a tablet in bed, physically worn visual aids, such as eyeglasses or contact lenses may be uncomfortable.

Moreover, many such smart devices are used more frequently in a careless manner, for example, tossed onto night stands, shoved into pockets with keys and other metal objects, or dropped from table edges. Therefore, the often-delicate screens of these smart devices are in jeopardy of irreversible damage.

Accordingly, it would be desirable to have smart device accessories that produce clear images, allowing individuals to accurately view their smart devices without eyeglasses or contact lenses. It would be further desirable to have a smart device accessory that both corrects the image and provides protection to the smart device's delicate display.

### SUMMARY

In an embodiment, the invention of the present disclosure may be an overlay for use with a smart device having a touch screen, the overlay comprising a protective layer configured to prevent damage to the touch screen, the protective layer having a protective layer height; a corrective layer configured to correct an image displayed by the touch screen, the corrective layer having a corrective layer prescription and a corrective layer height, wherein the corrective layer prescription is a function of at least a viewing distance and a user prescription, wherein the viewing distance is the distance between a user's eyes and the touch screen, and wherein the user prescription is the prescription of a user's visual aid apparatus; and an adhesive layer configured to attach the overlay to the touch screen, the adhesive layer having an adhesive layer height, wherein the adhesive layer is disposed above the touch screen, the corrective layer is disposed above the adhesive layer, and the protective layer is disposed above the corrective layer, and wherein the protective layer, the corrective layer, and the adhesive layer each have the same surface area.

The overlay may further comprise a border disposed around a perimeter of the overlay, the border having a border height, wherein the border height is equivalent to a sum of the adhesive layer height, the corrective layer height, and the protective layer height. In an embodiment, the border is opaque.

Further, the overlay may comprise a filler layer having a filler layer height, the filler layer disposed between the corrective layer and the adhesive layer. In an embodiment, the filler layer has an index of refraction less than 1.55.

In an embodiment, the smart device comprises one or more processors, one or more computer-readable memories, a front-facing camera, and one or more computer-readable storage devices, and program instructions stored on at least one of the one or more computer-readable storage devices for execution by at least one of the one or more processors via at least one of the one or more computer-readable memories, the stored program instructions comprising: receiving, via the touch screen, the user prescription and the corrective layer prescription; determining, via the one or more processors and the front-facing camera, the viewing distance; modifying, via the one or more processors, a visual output based on at least the user prescription, the corrective layer, and the viewing distance; and displaying, via the touch screen, a modified visual output.

In a further embodiment, the corrective layer prescription is one of one or more standard prescriptions. The one or more standard prescriptions may comprise a nearsightedness prescription and a farsightedness prescription, wherein the nearsightedness prescription is configured to clarify images for a nearsighted user, and wherein the farsightedness prescription is configured to clarify images for a farsighted user.

### BRIEF DESCRIPTION OF THE DRAWINGS

The incorporated drawings, which are incorporated in and constitute a part of this specification exemplify the aspects of the present disclosure and, together with the description, explain and illustrate principles of this disclosure.

FIG. 1 is an illustrative block diagram of a system based on a computer.

FIG. 2 is an illustration of a computing machine.

FIG. 3A is an illustration of an overlay having at least a corrective layer and a protective layer.

FIG. 3B is an illustration of an overlay having at least a corrective layer, a protective layer, and a filler layer.

FIG. 3C is a right perspective view of an embodiment of an overlay.

FIG. 4 is an illustration depicting an embodiment of an overlay interfacing with a smart device.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

The present disclosure relates to an apparatus for image correction and screen preservation.

Those skilled in the art will realize that storage devices utilized to provide computer-readable and computer-executable instructions and data can be distributed over a network. For example, a remote computer or storage device may store computer-readable and computer-executable instructions in the form of software applications and data. A local computer may access the remote computer or storage device via the network and download part or all of a software application or data and may execute any computer-executable instructions. Alternatively, the local computer may download pieces of the software or data as needed, or process the software in a distributive manner by executing some of the instructions at the local computer and some at remote computers and/or devices.

Those skilled in the art will also realize that, by utilizing conventional techniques, all or portions of the software's computer-executable instructions may be carried out by a dedicated electronic circuit such as a digital signal processor (“DSP”), programmable logic array (“PLA”), discrete circuits, and the like. The term “electronic apparatus” may include computing devices or consumer electronic devices comprising any software, firmware or the like, or electronic devices or circuits comprising no software, firmware or the like.

The term “firmware” as used herein typically includes and refers to executable instructions, code, data, applications, programs, program modules, or the like maintained in an electronic device such as a ROM. The term “software” as used herein typically includes and refers to computer-executable instructions, code, data, applications, programs, program modules, firmware, and the like maintained in or on any form or type of computer-readable media that is configured for storing computer-executable instructions or the like in a manner that may be accessible to a computing device.

The terms “computer-readable medium”, “computer-readable media”, and the like as used herein and in the claims are limited to referring strictly to one or more statutory apparatus, article of manufacture, or the like that is not a signal or carrier wave per se. Thus, computer-readable media, as the term is used herein, is intended to be and must be interpreted as statutory subject matter.

The term “computing device” as used herein and in the claims is limited to referring strictly to one or more statutory apparatus, article of manufacture, or the like that is not a signal or carrier wave per se, such as computing device 101 that encompasses client devices, mobile devices, wearable devices, one or more servers, network services such as an Internet services or corporate network services based on one or more computers, and the like, and/or any combination thereof. Thus, a computing device, as the term is used herein, is also intended to be and must be interpreted as statutory subject matter.

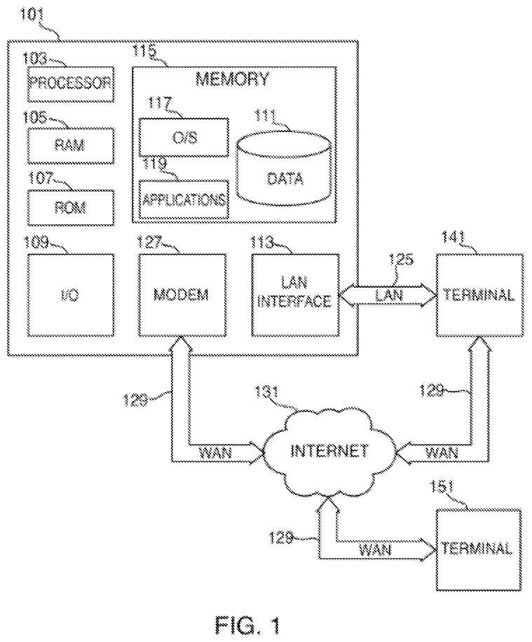

FIG. 1 is an illustrative block diagram of system 100 based on a computer 101. The computer 101 may have a processor 103 for controlling the operation of the device and its associated components, and may include RAM 105, ROM 107, input/output module 109, and a memory 115. The processor 103 will also execute all software running on the computer—e.g., the operating system. Other components commonly used for computers such as EEPROM or Flash memory or any other suitable components may also be part of the computer 101.

The memory 115 may be comprised of any suitable permanent storage technology—e.g., a hard drive. The memory 115 stores software including the operating system 117 any application(s) 119 along with any data 111 needed for the operation of the system 100. Alternatively, some or all of computer executable instructions may be embodied in hardware or firmware (not shown). The computer 101 executes the instructions embodied by the software to perform various functions.

Input/output (“I/O”) module may include connectivity to a microphone, keyboard, touch screen, and/or stylus through which a user of computer 101 may provide input, and may also include one or more speakers for providing audio output and a video display device for providing textual, audiovisual and/or graphical output.

System 100 may be connected to other systems via a LAN interface 113.

System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129, but may also include other networks. When used in a LAN networking environment, computer 101 is connected to LAN 125 through a LAN interface or adapter 113. When used in a WAN networking environment, computer 101 may include a modem 127 or other means for establishing communications over WAN 129, such as Internet 131.

It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program(s) 119, which may be used by computer 101, may include computer executable instructions for invoking user functionality related to communication, such as email, Short Message Service (SMS), and voice input and speech recognition applications.

Computer 101 and/or terminals 141 or 151 may also be devices including various other components, such as a battery, speaker, and antennas (not shown).

Terminal 151 and/or terminal 141 may be portable devices such as a laptop, cell phone, smartphone, smartwatch, or any other suitable device for storing, transmitting and/or transporting relevant information. Terminals 151 and/or terminal 141 may be other devices. These devices may be identical to system 100 or different. The differences may be related to hardware components and/or software components.

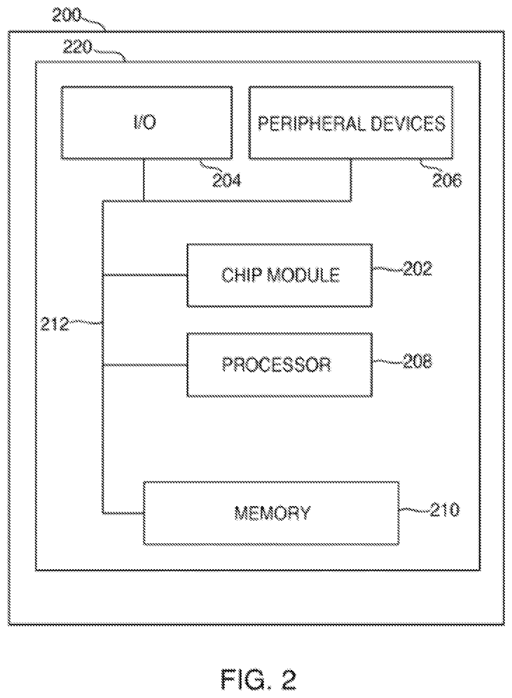

FIG. 2 shows illustrative apparatus 200. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations. The apparatus 200 may be any smart phone, tablet, or mobile device. Such an apparatus 200 may be configured to display video and present images.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable encoded media or devices; peripheral devices 206, which may include counter timers, real-time timers, power-on reset generators or any other suitable peripheral devices; logical processing device 208, which may test submitted information for validity, scrape relevant information, aggregate user financial data and/or provide an auth-determination score(s) and machine-readable memory 210.

Machine-readable memory 210 may be configured to store in machine-readable data structures: information pertaining to a user, information pertaining to an account holder and the accounts which he may hold, the current time, information pertaining to historical user account activity and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

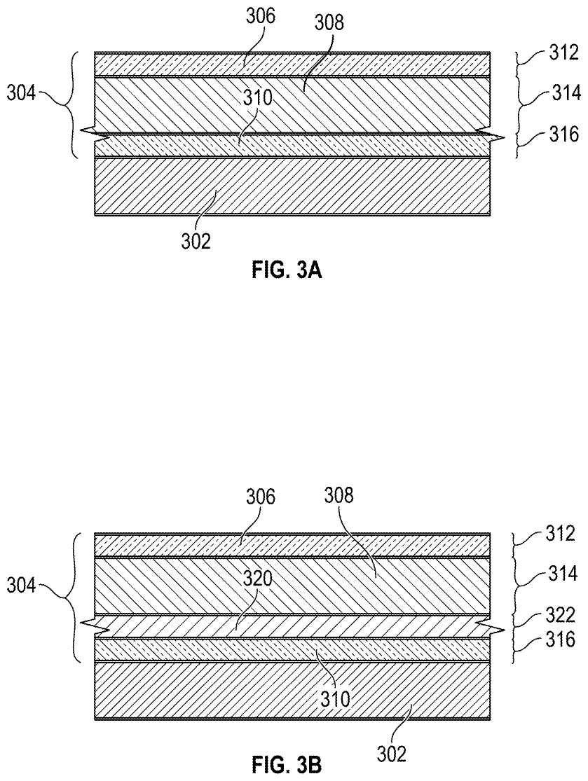

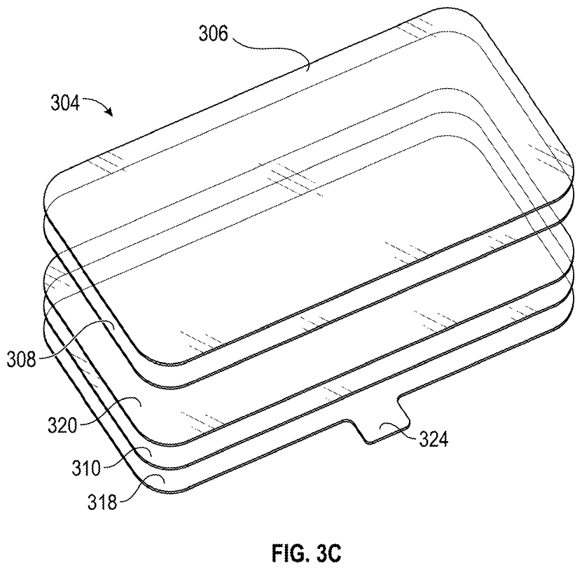

Referring to FIG. 3A, the invention of the present disclosure may include a touch screen 302. The touch screen 302 may be in electrical communication with processor 103, RAM 105, ROM 107, input/output module 109, and/or memory 115. Accordingly, interactions with the touch screen 302 may influence underlying software. Moreover, the touch screen 302 may display a visual output. For example, the visual output may include a graphical user interface (“GUI”). Any suitable variant of touch screen 302 may be utilized. As a non-limiting example, the touch screen 302 may include a touch-sensitive surface, and one or more sensors configured to capture input from the user (for example, the tactile pressure from a user's finger). Thus, a user may make contact with the screen in order to transmit information to the device. The touch screen 302 may be an LCD, LED, or LPD screen. However, any suitable display may be utilized. The computer 101, via the touch screen 302, may determine contact by the user's finger and evaluate said contact to execute functions. In one embodiment, the touch screen 302 may be a capacitive touch screen. However, in further embodiments, the touch screen 302 may utilize any suitable touch screen technology.

An auxiliary layer 304 (also referred to herein as “overlay 304”) may include a protective layer 306, a corrective layer 308, and an adhesive layer 310. The protective layer 306 may have a protective layer height 312, the corrective layer 308 may have a corrective layer height 314, and an adhesive layer height 316. Further, the auxiliary layer 304 may include a removable retaining layer 318 disposed below the adhesive layer 310.

The total height of the overlay 304 may be sufficiently thin to enable the computer 101 to detect field effect changes when a user touches the overlay 304, in effect enabling the user to make selections as presented on the touch screen 302 by touching the same coordinates on the overlay 304. The computer 101 may increase the sensitivity of the touch screen 302 such that the computer 101, via the touch screen 302, may determine contact by a user's finger against the overlay 304. The touch screen 302 sensitivity may be configured as a function of the height of each layer within the auxiliary layer 304. For example, the computer 101 may increase the sensitivity of the touch screen 302 for thicker overlays 304, and decrease the sensitivity of the touch screen 302 for thinner overlays 304. The thicknesses of each layer within the overlay 304 may be a function of a user prescription.

The computer 101 may be configured to reduce or increase the size of an image displayed on the touch screen 302 depending on the thickness and prescription of the corrective layer 308. The image displayed on the touch screen 302 may be suitably sized, via the computer 101, such that, when viewed through the overlay 304, the image fills the total surface area of the overlay 304 when viewed by the user. The computer 101 may appropriately size an image displayed on the touch screen 302 be configuring a display area of the touch screen 302.

In an embodiment, the corrective layer prescription may be configured for general magnification. For example, the corrective layer prescription may be configured to magnify the received image from the touch screen 302 by 1.2×. However, the corrective layer 308 may be configured to magnify the image by any suitable magnitude. Accordingly, the computer 101 may reduce the area of the image on the touch screen 302, such that the corrective layer 308 magnifies the image to fill the area of the overlay 304. Moreover, the corrective layer height 314 may be a function of the magnitude of magnification. For example, a greater magnitude of magnification may require a taller corrective layer height 314. Thus, the computer 101 may account for the corrective layer height 314 and the corrective layer prescription when reducing the area of the image as it appears on the touch screen 302. In other words, the reduction in area of the image on the touch screen 302 is a function of the corrective layer height 314 and corrective layer prescription. The user may enter the prescription and/or corrective layer height 314 into the apparatus 200 via a graphical user interface on the touch screen 302.

The protective layer 306 may be a transparent rigid member. Further, the protective layer 306 may be composed of a sturdy, scratch-resistant, material, for example, polyethylene terephthalate, thermoplastic polyurethane, tempered glass, or another strengthened form of glass. The protective layer 306 may have a protective layer height 312 sufficient to prevent gouges that would otherwise extend into, and damage, the corrective layer 308.

The corrective layer 308 may enable a user with impaired eyesight to better see the touch screen 302, without the use of corrective eyeglasses. Thus, the corrective layer 308 may have an associated prescription. The corrective layer 308 may be configured as a lens, wherein the lens corrects images from the touch screen 302 such that a user with impaired vision sees a clearer image. In an embodiment, the corrective layer 308 may be convex, concave, or otherwise formed to bend light, such that the resulting light transmits a clearer image to the user. Accordingly, the curvature and corrective layer height 314 is a function of the user's eyesight (for example, their glasses prescription). In an alternate embodiment, the corrective layer 308 may include a plurality of lenses, each lens disposed above one (or another relatively small number of) pixel.

The prescription of the corrective layer 308 is a function of the distance at which the apparatus 200 is held from the user's eyes, as well as the user's eyesight. Thus, a corrective layer 308 may be crafted to correct visuals for a user's preferred viewing distance.

Referring to FIG. 3B, in an alternate embodiment, the auxiliary layer 304 may include a filler layer 320 disposed between the corrective layer 308 and the adhesive layer 310. The filler layer 320 may have a filler layer height 322. The filler layer 320 may be configured with a neutral effect on traversing light (for example, an index of refraction near 1 or less than 1.55). Thus, the filler layer 320 may act as a buffer between the adhesive layer 310 and the corrective layer 308. Further, the filler layer 320 may provide a filler layer distance 322, which may provide a necessary spacing between the corrective layer 308 and the touch screen 302. For example, the filler layer distance 322 may be the distance between the image and the corrective layer 308 that facilitates a clear image for the user. Accordingly, the prescription of the corrective layer 308 may be a function of the user's eyesight (for example, eyeglass prescription), the viewing distance (for example, distance from the user's eyes to corrective layer 308), the distance between the corrective layer 308 and the touch screen 302 (for example, the adhesive layer height 316 or, if the overlay 304 includes a filler layer 320, the sum of the adhesive layer height 316 and the filler layer height 322).

In another embodiment, in addition to, or instead of tailoring the corrective layer 308 to the eyesight and viewing distance of the user, the computer 101 may modify the image on the touch screen 302. In such an embodiment, the corrective layer 308 may be one of a plurality of standard prescriptions (for example, a general prescription for nearsightedness or a general prescription for farsightedness). However, a single corrective layer 308 may be utilized.

The computer 101 may receive the user's eyeglass prescription and likely viewing distance. However, in another embodiment, the likely viewing distance may be determined by a front facing camera and depth-determining software, wherein the computer 101 and the front facing camera are configured to determine the distance between the user's eyes and the apparatus 200. For example, the computer 101 may be configured to adjust the brightness, clarity, saturation, and/or intensity of the image and the frequency of the light composing the image. The computer 101 may modify the image, such that the modified image, as viewed through, the standard corrective layer is clearer to the user.

Further, the computer 101 may present the user with a graphical user interface, via the touch screen 302, enabling the user to adjust parameters of the video output, to fine tune the modified image.

In an embodiment, a tab 324 may be disposed on the removeable retaining layer 318, enabling a user to remove a protective film from the adhesive layer 310. In removing the protective film from the adhesive layer 310, a user may expose the adhesive layer 310 to enable the auxiliary layer 304 to be secured to the exposed adhesive layer 310.

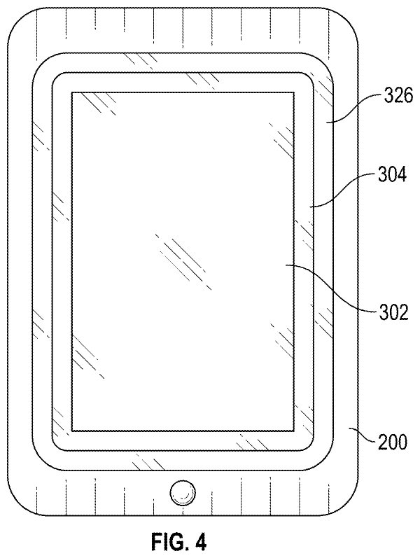

Referring to FIG. 4, the auxiliary layer 304 may be bound by a border 326. The border 326 may surround the outside perimeter of the auxiliary layer 304. In an embodiment, the border 326 may be opaque, such that light may not enter the outer sides of the auxiliary layer 304. The border 326 may be attached to the auxiliary layer 304 with an adhesive or may be held in place by retention. The border 326 may be elastic, such that the border 326 compresses the outside walls of the auxiliary layer 304, wherein the compression maintains the position of the border 326. In one embodiment, the adhesive layer 310 may traverse the bottom surface of the border 326, as well as the bottom surface of the corrective layer 308. In another embodiment, the adhesive layer 310 may traverse the bottom surface of the corrective layer 308, but not the border 326. In yet another embodiment, the adhesive layer 310 may traverse the bottom surface of the border 326 and the corrective layer 308 or filler layer 320 may rest directly upon the touch screen 302.

In an embodiment, the auxiliary layer 304 may be sized to cover the entire front portion of the apparatus 200 (for example, the top surface of the apparatus 200). However, in another embodiment, as shown in FIG. 4, the auxiliary layer 304 may be sized to cover at least the touch screen 302.

Finally, while certain novel features of the present invention have been shown and described, it will be understood that various omissions, substitutions and changes in the forms and details of the device illustrated and in its operation can be made by those skilled in the art without departing from the spirit of the invention.

What is claimed is:

1. An overlay for use with a smart device having a touch screen, the overlay comprising:
a protective layer configured to prevent damage to the touch screen, the protective layer having a protective layer height;
a corrective layer configured to correct an image displayed by the touch screen, the corrective layer having a corrective layer prescription and a corrective layer height,
wherein the corrective layer prescription is a function of at least a viewing distance and a user prescription,
wherein the viewing distance is the distance between a user's eyes and the touch screen, and
wherein the user prescription is the prescription of a user's visual aid apparatus; and
an adhesive layer configured to attach the overlay to the touch screen, the adhesive layer having an adhesive layer height,
wherein the adhesive layer is disposed above the touch screen, the corrective layer is disposed above the adhesive layer, and the protective layer is disposed above the corrective layer, and
wherein the protective layer, the corrective layer, and the adhesive layer each have the same approximate surface area.

2. The overlay of claim 1, further comprising a border disposed around a perimeter of the overlay, the border having a border height,
wherein the border height is equivalent to a sum of the adhesive layer height, the corrective layer height, and the protective layer height.

3. The overlay of claim 2, wherein the border is opaque.

4. The overlay of claim 1, further comprising a filler layer having a filler layer height, the filler layer disposed between the corrective layer and the adhesive layer.

5. The overlay of claim 4, wherein the filler layer has an index of refraction less than 1.55.

6. The overlay of claim 1, wherein the smart device comprises one or more processors, one or more computer-readable memories, a front-facing camera, and one or more computer-readable storage devices, and program instructions stored on at least one of the one or more computer-readable storage devices for execution by at least one of the one or more processors via at least one of the one or more computer-readable memories, the stored program instructions comprising:
receiving, via the touch screen, the user prescription and the corrective layer prescription;
determining, via the one or more processors and the front-facing camera, the viewing distance;
modifying, via the one or more processors, a visual output based on at least the user prescription, the corrective layer, and the viewing distance; and
displaying, via the touch screen, a modified visual output.

7. The overlay of claim 6, wherein the corrective layer prescription is one of one or more standard prescriptions.

8. The overlay of claim 7, wherein the one or more standard prescriptions comprise a nearsightedness prescription and a farsightedness prescription, wherein the nearsightedness prescription is configured to clarify images for a nearsighted user, and wherein the farsightedness prescription is configured to clarify images for a farsighted user.

9. The overlay of claim 6, wherein the stored program instructions further include:
determining, from the corrective layer prescription, an overlay thickness; and
adjusting a sensitivity of the touch screen based on the overlay thickness,
wherein the sensitivity of the touch screen increases as the overlay thickness increases, and
wherein the sensitivity of the touch screen decreases as the overlay thickness decreases.

10. The overlay of claim 6, wherein the stored program instructions further include:
determining, from the corrective layer prescription, an overlay thickness; and
defining, via the one or more processors, a display area of the touch screen based on the corrective layer prescription.

11. A computer-readable storage medium having data stored therein representing software executable by a computer, the software having instructions to:
receive, via a touch screen, a user prescription and a corrective layer prescription;
determine, via one or more processors and a front-facing camera, a viewing distance;
modify, via the one or more processors, a visual output based on at least the user prescription, a corrective layer, and the viewing distance;
display, via the touch screen, a modified visual output;
determine, from the corrective layer prescription, an overlay thickness; and
adjust, via the one or more processors, a sensitivity of the touch screen based on the overlay thickness,
wherein the sensitivity of the touch screen increases as the overlay thickness increases, and
wherein the sensitivity of the touch screen decreases as the overlay thickness decreases.
